(19) United States
(12) Patent Application Publication
(10) Pub. No.: US 2016/0123504 A1
(43) Pub. Date: May 5, 2016

(54) COMPOSITE MATERIAL COMPOSITION FOR NEUTRALIZING ACID COMPOUNDS AND PIPE COMPRISING A SHEATH MADE FROM SAME

(71) Applicants: IFP ENERGIES NOUVELLES, Rueil-Malmaison (FR); TECHNIP FRANCE, Courbevoie (FR)

(72) Inventors: David PASQUIER, LYON (FR); Serge GONZALEZ, JONAGE (FR); Xavier LEFEBVRE, CONFLANS SAINTE HONORINE (FR); Saliha BENGUESMIA, VENISSIEUX (FR); Emmanuelle TRELA-BAUDOT, VERNAISON (FR); Thomas EPSZTEIN, ROUEN (FR); Frédéric DEMANZE, CHAVILLE (FR)

(21) Appl. No.: 14/897,821

(22) PCT Filed: May 13, 2014
(86) PCT No.: PCT/FR2014/051106

§ 371 Date: Dec. 11, 2015

(30) Foreign Application Priority Data
Jun. 13, 2013 (FR) 13 55480

(51) Int. Cl. F16L 11/08; B32B 15/08; B32B 27/18; F16L 9/147; B32B 27/34; C23F 11/04; F16L 58/10; B32B 1/08; B32B 27/30

(52) U.S. Cl. CPC F16L 11/08; B32B 1/08; B32B 15/08; B32B 27/18; B32B 27/304; B32B 27/34; C23F 11/04; F16L 58/10; F16L 9/147; B32B 2250/02; B32B 2264/102; B32B 2307/714; B32B 2597/00

(57) ABSTRACT

The invention relates, on the one hand, to a composite material composition capable of neutralizing acid compounds and of being used under high temperature conditions, said composition being a mixture of a polymer material with a predetermined amount of reactive fillers, the mass fraction of the chemically active products ranges between 4 and 40% and the polymer material is selected from the vinylidene fluoride copolymers family, comprising a vinylidene fluoride monomer, and at least one monomer being selected from among the following monomers: hexafluoropropylene, perfluoro(methylvinyl)ether, perfluoro(ethylvinyl)ether, perfluoro (propylvinyl)ether, tetrafluoroethylene, perfluorobutylethylene, fluoropropylene, chlorotrifluoroethylene, chlorodifluoroethylene, chlorofluoroethylene, trifluoroethylene, and the monomer with the following formulation: CH₂═CH—CF₂—(CF₂)₄—CF₃ and, on the other hand, to a pipe comprising at least one sheath made from the composite material composition.

### FIELD OF THE INVENTION

The present invention relates to the field of pipes intended for transportation of petroleum fluids containing acid compounds such as hydrogen sulfide H₂S and/or carbon dioxide CO₂.

The invention notably applies to hydrocarbons transported in pipes likely to undergo high pressures, above 100 bar, and high temperatures, above 90° C. or even 130° C., during long time intervals, i.e. several years. The pipes are notably used for offshore oil development.

The pipes can be metal tubes lined with a polymer material sheath. The pipes can also be flexible pipes consisting of superposed polymer sheaths and of one or more layers of helically wound metal wires.

### BACKGROUND OF THE INVENTION

During transportation of a petroleum effluent under high pressure and high temperature conditions, acid compounds such as H₂S and CO₂ tend to migrate through the polymer sheath until they reach the metallic parts of the pipe and cause corrosion thereof. Corrosion involves risks for the mechanical integrity of the pipe that undergoes high stresses due to the own weight thereof on the one hand and to the high pressure of the petroleum effluent and of the marine environment on the other hand. These migration and corrosion mechanisms are amplified notably by temperature and by the acid species contents.

Document EP-844,429 proposes to introduce, into a sheath made of a polymer material, chemically active products with the acid compounds (H₂S and/or CO₂) so as to irreversibly neutralize the corrosive effects of said acid compounds and to avoid corrosive effects on the metallic parts of the pipe.

Patent application FR-2,932,870 is an improvement of patent EP-844,429 that aims to use chemically active products with a particular specific surface area (above 5 m²/g) in order to enhance the reaction with the acid compounds.

These materials, which are reactive barriers making up a sheath, referred to as anti-H₂S materials, which can be formulated with a polyolefin type (polyethylene for example) polymer matrix and a metal oxide, give consistent results but they do not enable operation above 90° C., notably because of the loss of mechanical properties of the matrix due to temperature and of the permeability increase thereof. For some applications, a material withstanding an operating temperature above 90° C. is however necessary.

Among the polymers mentioned in these documents, the polyethylenes, the polyamides (PE, PA) cannot be used at 130° C. because their mechanical properties at this temperature are lowered and the creep risk is prohibitive. In some cases, the polymers are not stable at this temperature (chemical degradation of the polyamide for example). Furthermore, one might consider using for this sheath fluoropolymers such as perfluoroalkoxy PFA, perfluoro methyl alkoxy MFA, perfluoro ethylene propylene FEP, poly(ethylene-co-tetrafluoroethylene) ETFE, poly(chloro-trifluoro-ethylene) CTFE which are presumably compatible with the desired application. However, either the transformation temperature of these polymers is high and requires a costly specific equipment, or the mechanical properties thereof are not suited for the application (elongation at yield too low, elastic modulus too high). On the other hand, in order to facilitate the implementation thereof, some polymers contain plasticizers whose concentration can vary during their use, which may lead to a change in properties during the life of the material.

Among the thermoplastics already commonly used as a sealing sheath in flexible pipes, only some poly(vinylidene fluorides) PVDF have sufficient chemical and mechanical properties at 130° C. for potentially meeting the sealing sheath application. However, for the PVDF polymers currently used, the mechanical properties thereof are not suited for the application when chemically active products are added. Indeed, adding active chemical products in large amounts modifies the mechanical characteristics of the polymers. With this addition, the PVDF polymers conventionally used in the prior art do not have sufficient mechanical characteristics and they notably become brittle, which prevents their use for neutralizing the corrosive effects of acids.

For gas cleaning processes, the same problems related to acid compounds neutralization and use at high temperature arise.

To overcome these drawbacks, the invention relates, on the one hand, to a composite material composition capable of neutralizing acid compounds and of being used under high temperature conditions, said composition being a mixture of a polymer material with a predetermined amount of reactive fillers, the mass fraction of the chemically active products ranges between 4 and 40% and the polymer material is selected from the vinylidene fluoride copolymers family, comprising at least one monomer selected from among the following monomers: hexafluoropropylene, perfluoro(methylvinyl)ether, perfluoro(ethylvinyl)ether, perfluoro(propylvinyl)ether, tetra-fluoroethylene, perfluorobutylethylene, fluoropropylene, chlorotrifluoroethylene, chloro-difluoroethylene, chlorofluoroethylene, trifluoroethylene, and the monomer with the following formulation: CH₂═CH—CF₂—(CF₂)₄—CF₃ and, on the other hand, to a pipe comprising at least one sheath made from the composite material composition. These materials allow the pipe to be used under high temperature conditions, i.e. above 90° C.

### SUMMARY OF THE INVENTION

The invention relates to a composite material composition for neutralizing at least one acid compound among carbon dioxide CO₂ and hydrogen sulfide H₂S, said composition comprising a mixture of a polymer material with a predetermined amount of chemically active products with said acid compound so as to irreversibly neutralize the corrosive effects of said acid compounds. The mass fraction of said chemically active products ranges between 4 and 40% and said polymer material is selected from the vinylidene fluoride copolymers family, comprising at least one monomer selected from among the following monomers: hexafluoropropylene, perfluoro(methylvinyl)ether, perfluoro(ethylvinyl)ether, perfluoro(propylvinyl)ether, tetrafluoroethylene, perfluoro-butylethylene, fluoropropylene, chlorotrifluoroethylene, chlorodifluoroethylene, chlorofluoroethylene, trifluoroethylene, and the monomer with the following formulation: CH₂═CH—CF₂—(CF₂)₄—CF_{3.}

According to one embodiment of the invention, the polymer material is a copolymer of poly-(tetrafluoroethylene-co-hexafluoropropylene-co-vinylidene fluoride) THV type.

According to a second embodiment of the invention, the polymer material is a copolymer of poly(vinylidene fluoride-co-hexafluoropropylene) PVDF-HFP type.

Advantageously, the polymer material is a mixture of several polymers.

According to the invention, the fluorinated vinylidene copolymer has a tensile modulus measured at 20° C. ranging between 300 MPa and 850 MPa, preferably between 400 MPa and 600 MPa, with either a tensile elongation at yield at ambient temperature above 12%, preferably above 15% and more preferably above 20%, or a behaviour similar to that of an elastomer.

Advantageously, the polymer material has a melting point temperature ranging between 140° C. and 250° C., preferably between 160° C. and 230° C.

According to the invention, said chemically active products are selected from among the metal oxides selected from the group consisting of Fe₂O₃, Mn₂O₃, Mn₃O₄, MnO₂, PbO, ZnO, NiO, CoO, CdO, CuO, SnO₂, MoO₃, Fe₃O, Ag₂O, CrO₂, CrO₃, Cr₂O₃, the alkaline and alkaline-earth oxides selected from among CaO, Ca(OH)₂ and MgO.

Alternatively, said chemically active products can be selected from among metal carbonates, metal chlorides, hydrated forms of metal carbonates and metal chlorides, hydroxylated forms of metal carbonates and metal chlorides, alkaline carbonates, alkaline-earth carbonates, alkaline chlorides, alkaline-earth chlorides, hydrated forms of alkaline carbonates, of alkaline-earth carbonates, of alkaline chlorides, of alkaline-earth chlorides and hydroxylated forms of alkaline carbonates, of alkaline-earth carbonates, of alkaline chlorides and of alkaline-earth chlorides.

Preferably, the mass fraction of said chemically active products ranges between 10 and 30%.

Advantageously, said chemically active products are introduced into said mixture in form of particles with a specific surface area above 5 m²/g, preferably above 50 m²/g and more preferably above 80 m²/g.

Besides, said chemically active products can be subjected to a chemical surface treatment with silanes.

Furthermore, said polymer material can comprise a processing aid.

Advantageously, the PVDF-HFP used comprises plasticizers with a concentration below 10% and preferably below 5%.

The PVDF-HFP material can contain a compatibilizing additive.

The invention furthermore relates to a pipe for transportation of a petroleum effluent comprising at least one acid compound among carbon dioxide CO₂ and hydrogen sulfide H₂S, said pipe comprising at least one metallic element and a tubular sheath, said metallic element being arranged outside of said sheath. Said sheath is made from the composition according to the invention.

Advantageously, said sheath comprises at least two layers, a first layer comprising a second polymer material, and a second layer comprising said composition according to the invention.

Preferably, said second layer is arranged within said first layer.

Preferably, said second polymer material is selected from among polyvinylidene fluoride PVDF, poly(vinylidene fluoride-co-hexafluoropropylene) PVDF-HFP, polyamides 11 and 12.

Furthermore, said first layer can also comprise lamellar fillers with a shape factor above 20, selected from among exfoliated talcs, micas, graphites.

Advantageously, said sheath also comprises adsorbent fillers that trap the acid compounds, the adsorbent fillers being selected from among activated carbon, zeolites and aluminas.

According to a variant embodiment of the invention, said metallic element is a metal reinforcement of a flexible pipe.

Alternatively, said metallic element is a metal tube of a rigid pipe.

### BRIEF DESCRIPTION OF THE FIGURES

Other features and advantages of the method according to the invention will be clear from reading the description hereafter of embodiments given by way of non limitative example, with reference to the accompanying figures wherein:

FIG. 1 illustrates a flexible pipe according to the invention,

FIG. 2 illustrates a rigid pipe according to the invention, and

FIG. 3 shows in detail a polymer sheath made up of two layers according to an embodiment of the invention.

### DETAILED DESCRIPTION

Composition According to the Invention

The invention relates to a composite material composition intended for neutralization of acid compounds such as hydrogen sulfide H₂S and/or carbon dioxide CO₂, and capable of being used under high temperature conditions, i.e. above 90° C. The composition according to the invention is furthermore intended for manufacture of sealing sheaths, the composition therefore needs to have certain properties for this application (mechanical properties for example: high tensile modulus, around 1000 MPa at ambient temperature), high elongation at break (above 10% at ambient temperature). The acid compounds to be neutralized are only those entering the material by permeation.

The composition comprises a mixture of a polymer material with a predetermined non-zero amount of chemically active products (also referred to as active fillers) so as to irreversibly neutralize the corrosive effects of the active compounds. In order to ensure good temperature resistance, the polymer material making up the matrix is selected from among fluorinated materials non sensitive to chemical degradation, by hydrolysis for example. In order to ensure mechanical properties allowing incorporation of active fillers, the fluorinated material is selected from among vinylidene fluoride copolymers, i.e. polymers whose main chain consists of two or three monomers of different chemical nature, one of the main monomers being vinylidene fluoride and the other monomers being selected from among the following monomers:

hexafluoropropylene,

perfluoro(methylvinyl)ether,

perfluoro(ethylvinyl)ether,

perfluoro(propylvinyl)ether,

tetrafluoroethylene,

perfluorobutylethylene,

fluoropropylene,

chlorotrifluoroethylene,

chlorodifluoroethylene,

chlorofluoroethylene,

trifluoroethylene, and

the monomer of formulation CH₂═CH—CF₂—(CF₂)₄—CF₃.

Preferably, the polymer material is selected from the vinylidene fluoride copolymers family, comprising a vinylidene fluoride monomer, and at least one monomer selected from among the following monomers: hexafluoropropylene, tetrafluoroethylene, perfluorobutylethylene and fluoropropylene.

The polymer matrices can be used alone or in admixture with a polymer of the same family. This polymer mixture affords all the characteristics required within the scope of the invention in terms of mechanical properties, barrier properties, and thermal and chemical resistance. In fact, the copolymers defined above involve the mechanical characteristics required at high temperature for acting as a sealing sheath and neutralizing the acid compounds. Addition of chemically active products in large amount (above 4 wt. %) modifies the mechanical characteristics of the polymers (elongation at break decrease for example), while this amount of chemically active products is necessary to improve the acid compound neutralization (notably in case of high H₂S contents in the boron). With this addition, the PVDF polymers conventionally used in the prior art do not exhibit adequate mechanical characteristics and they notably become brittle, which prevents their use as a flexible sealing sheath allowing neutralization of the corrosive effects of acid compounds. On the contrary, the fluorinated copolymers and terpolymers of the composition according to the invention (as defined above) are more flexible (prior to mixing) and they allow to obtain mechanical characteristics for the composite material suited to the use thereof as a sealing sheath and for neutralization of the acid compounds.

Advantageously, to provide the mechanical characteristics of the composition, the fluorinated copolymers and terpolymers of the composition can exhibit a behaviour close to that of an elastomer material (absence of yield point for a tensile stress) or a tensile modulus measured at 20° C. ranging between 300 MPa and 850 MPa, preferably between 400 MPa and 600 MPa, and a tensile elongation at yield at ambient temperature above 12%, preferably above 15% and more preferably above 20%. Besides, the polymer material can have a melting temperature ranging between 140° C. and 250° C., preferably between 160° C. and 230° C., in order to ensure the temperature resistance of the composition and to prevent a decrease in the technical characteristics when the composition is used under high temperature conditions.

By way of non limitative example, the polymer material is selected from among the poly-(tetrafluoroethylene-co-hexafluoropropylene-co-vinylidene fluoride) terpolymers family notably marketed as THV® by the Dyneon company (3M), or among the poly(vinylidene fluoride-co-hexafluoropropylene) PVDF-HFP type copolymers, plasticized or not. These polymers enable use of the pipe under high temperature conditions, i.e. at temperatures above 90° C. and preferably above 120° C.

The THV® polymer is known as a terpolymer: it consists of a statistical sequence of the following three monomers: tetrafluoroethylene, hexafluoropropylene and vinylidene fluoride. These two polymers of interest to the invention have advantageous mechanical properties for the application, such as high elongation at break, low elastic modulus (less than or substantially equal to 850 MPa), good thermal and chemical resistance. These mechanical properties allow incorporation of a sufficiently large volume fraction of active fillers to obtain a high volume reactivity to acid gases, without sacrificing the mechanical properties under high temperature. The H₂S permeability properties at high temperature of these materials are satisfactory. The THV polymers according to the invention have a substantially zero plasticizer content. The molar mass of these THV polymers is so selected that the melting point thereof is above 120° C., preferably above 140° C. and more preferably above 160° C.

Furthermore, some THV® grades allow a continuous use temperature at a temperature above 90° C. and preferably above 130° C., among which the THV 815 GZ grade marketed by the Dyneon® company can be mentioned for example.

Among the PVDF-HFPs, the Kynar Flex® range of the Arkema® company and the Solef® range marketed by the Solvay Solexis® company can be mentioned. Among the PVDF-HFPs, the polymer matrix preferably comprises a molar fraction of the HFP monomer at least above 5% and preferably above 10%, in order to ensure good mechanical characteristics to the composition. For the PVDF-HFPs of interest to the application, the plasticizer content of the polymers is either zero or necessarily below 10 mass %, and it preferably ranges between 0 and 5 mass %. The mixture is prepared at a temperature above the melting temperature of the polymer material during the sheath extrusion operations. The neutralizing agents can be distributed over the entire thickness of the composition.

The agents neutralizing the acid compounds (reactive fillers) are selected from among metal oxides (Fe₂O₃, Mn₂O₃, Mn₃O₄, MnO₂, PbO, ZnO, NiO, CoO, CdO, CuO, SnO₂, MoO₃, Fe₃O₄, Ag₂O, CrO₂, CrO₃, Cr₂O₃, TiO, and Ti₂O₃) or alkaline or alkaline-earth oxides (CaO, Ca(OH)₂, MgO). A single type of neutralizing agent or a combination of different neutralizing agents can be used, for example a combination of several metal oxides, a combination of metal oxides with alkaline or alkaline-earth oxides.

The chemically active products can also be selected from among metal carbonates (ZnCO₃ for example) or metal chlorides (ZnCl₂ for example), as well as hydrated and/or hydroxylated forms of metal carbonates and metal chlorides (2 ZnCO₃.3H₂O, Zn(OH)₂, Zn₅(CO₃)₂(OH)₆ or [Zn(OH)₂]₃.(ZnCO₃)₂ for example). The chemically active products can also be selected from among alkaline carbonates, alkaline-earth carbonates, alkaline chlorides and alkaline-earth chlorides (Na₂CO₃ or CaCO₃ for example), as well as hydrated and/or hydroxylated forms of alkaline carbonates, alkaline-earth carbonates, alkaline chlorides and alkaline-earth chlorides.

For the aforementioned neutralizing agents, the reaction principle consists in converting oxidized, carbonated, chlorinated (possibly in hydrated and/or hydroxylated form) to sulfurized derivatives (in the case of a reaction with H₂S) or carbonated derivatives (in the case of a reaction with CO₂). Of course, when only CO₂ is present, the carbonated forms of the metallic derivatives, the alkaline derivatives and the alkaline-earth derivatives are not selected.

Indeed, the present invention is mainly based on some known chemical reactions conducted in the field of acid gas cleaning processes, notably acid gases resulting from the presence of H₂S and CO₂.

The following reactions, irreversible under the conditions of the application, can be mentioned by way of example:

for the fillers comprising metal oxides:

PbO+H₂S→PbS+H₂O

ZnO+H₂S→ZnS+H₂O

Fe₂O₃+4H₂S→2FeS₂+3H₂O+H₂.

The same applies with the other metal oxides.

for the fillers comprising alkaline or alkaline-earth oxides:

CaO+H₂S→CaS+H₂O

CaO+CO₂→CaCO₃.

According to the invention, the mass proportion (also referred to as mass fraction) of agents neutralizing the acid compounds in the mixture can range between 4 and 40 mass %, preferably between 10 and 30%. Indeed, for mass concentrations below 4%, the thickness of the composite material composition required to obtain an acceptable efficiency might be too high to allow use in common applications for acid compound composition neutralization, notably as a sealing sheath in a flexible pipe. For acid compound neutralizing agents in mass concentrations above 40%, the mechanical strength properties of the composition could be incompatible with a use of the composition for the flexible sealing sheath application. In fact, adding a filler to the polymer matrix tends to modify the mechanical properties, notably to increase the elastic modulus and to decrease the elongation at yield and the elongation at break. A mass fraction ranging between 10 and 30% allows a good compromise to be obtained in terms of volume reactivity and mechanical properties.

Advantageously, agent fillers neutralizing the acid compounds are selected with a specific surface area above 5 m²/g, preferably at least above 50 m²/g and more preferably yet above 80 m²/g. Indeed, it has been discovered that the specific surface area of the fillers is critical for the competition between the reaction of the acid gases with the neutralizing agent fillers and the gas permeation phenomenon through the polymer matrix. For the same mass fraction of neutralizing agent fillers in the matrix, the efficiency of said filler is all the higher as the specific surface area thereof is large. In fact, the efficiency of a reactive filler in a polymer sheath is related to the mass yield of the filler, i.e. the number of moles of reactive fillers that will react with the acid compounds, and to the time required for the acid compounds to flow through the filler-laden polymer sheath. It has been shown (reference can notably be made to the examples given in patent application FR-2,932,870) that the larger the specific surface area of the reactive filler, the more acid-filler reactions at the filler surface, the fastest, and therefore the longer the time required for the active molecules to flow through the laden polymer sheath. This corresponds, for a given mass fraction of reactive fillers, to a higher efficiency of said filler.

A standard method for measuring the specific surface area of a solid is based on the physical adsorption of a gas such as nitrogen on the surface of said solid (BET [Brunauer, Emmett, Teller] method).

Various mixtures were prepared with fillers likely to neutralize acid gases, such as metal oxides, Fe₂O₃ and ZnO for example. Table 1 gives the composition of some mixtures prepared in a co-rotating twin-screw extruder. In this table, tests 1 to 5 relate to polymers according to the invention, example 6 relates to a PVDF homopolymer not in accordance with the invention.

TABLE 1
Composition examples

| | | Young's | | | | | Volume |
|---|---|---|---|---|---|---|---|
| | | modulus | Elongation at | | | | reactivity |
| | | polymer | yield | | | | (mol |
| | | alone | polymer alone | | Filler rate | | H₂S/dm³ |
| Test | Polymer | (MPa) | (%) | Filler | in mass % | Density | composite) |
| 1 | THV 815GZ | 625 | >20% | Fe₂O₃ | 15 | 2.27 | 8.52 |
| 2 | THV 815GZ | 625 | >20% | Fe₂O₃ | 25 | 2.43 | 15.21 |
| 3 | THV 815GZ | 625 | >20% | ZnO | 20 | 2.36 | 5.80 |
| 4 | KynarFlex 3120- | 821 | 12.2 | ZnO | 20 | 2.36 | 5.80 |
| | 50 (PVDF-HFP) | | | | | | |
| 5 | KynarFlex 3120- | 821 | 12.2 | Fe₂O₃ | 15 | 2.27 | 8.52 |
| | 50 (PVDF-HFP) | | | | | | |
| 6 | Homopolymer | 2030 | 11.5 | Fe₂O₃ | 15 | | |
| | PVDF Kynar | | | | | | |
| | 720HD | | | | | | |

For the PVDF homopolymers not in accordance with the invention (test 6), it can be seen that, for the same mass fraction of filler, the modulus increases and the elongation at break decreases (compared to test 1 for example) in too large proportions, which makes them incompatible with the desired application.

TABLE 2
Mechanical properties measured on type 5A samples
(standard ISO 527-2) of several compositions

| | Ratio between the | Ratio between the |
|---|---|---|
| | tensile modulus of the | elongation at break of the |
| | composition of the test | composition of the test and |
| | and the tensile modulus | the elongation at break of |
| | of the THV815GZ laden | the THV815GZ laden with |
| Test | with 15% Fe₂O₃ | 15% Fe₂O₃ |
| 6 | 3.22 | 0.11 |
| 5 | 1.17 | 1.03 |
| 1 | 1 | 1 |

Table 2 shows that tests 1 and 5 according to the invention have adequate mechanical properties whereas test 6 (PVDF homopolymer not in accordance with the invention) is not compatible with the application because its mechanical properties are not acceptable for acid compound neutralization, notably as a flexible pipe sheath; indeed, the tensile modulus is too high and the elongation at break is too low.

Using reactive fillers in admixture with polymer materials can induce mechanical property changes and cause implementation problems upon extrusion and shaping of the composite sheath. According to the invention, additives allowing to limit composition flow defects and to improve the mechanical properties of the sheath can be added. The additives can be added upon mixing the polymer material with the reactive agents, at a temperature above the melting temperature of the polymer material. According to an embodiment of the invention, the polymer material can comprise a processing aid. Examples of fillers that can be added are polytetrafluoroethylene, mica, silica, barium sulfate, an example of conducting agent that can be added is carbon black, examples of plasticizers that can be added are dioctyl phthalate and pentaerythritol, examples of processing aids that can be added are sulfonated or fluorinated compounds, low molar mass polyethylenes.

The creation of strong interfaces between the acid compound neutralizing agent and the polymer of the sealing sheath can also be promoted. Thus, the acid compound neutralizing agent can be subjected to a chemical surface treatment with silanes. Compounds allowing the filler-matrix interactions to be increased can also be added. In the case of PVDF-HFPs, a proportion of a functionalized copolymer of same nature as the Kynar ADX® marketed by Arkema® can be introduced for example.

According to the invention, the stage of preparing and implementing the mixture of polymer material and of chemically reactive fillers with the acid compounds H₂S and/or CO₂ is important. Indeed, preferably, the chemically reactive fillers are homogenously distributed in the polymer material. In fact, homogeneous distribution of the reactive fillers allows the acid compounds to be neutralized throughout the volume of the sheath and prevents the formation of preferential acid compound passageways in the sheath, which would lead to a rapid release of the acid compounds through the sheath and thus to low efficiency. Furthermore, a heterogeneous local concentration of reactive fillers in the sheath could cause weak mechanical resistance of the sheath.

The chemically active fillers with acid compounds can be introduced into the base polymer either in form of a dry powder or in form of a solid suspended in a liquid or even pasty phase. Introduction can be achieved upon the compounding stage or through the use of a master batch known to the person skilled in the art.

In order to improve dispersion of the fillers in the polymer matrix, the surface of the reactive fillers can for example be chemically modified, or dispersing agents can be added. It is also possible to modify the profiles of the extrusion screw, the operating conditions such as flow rate, temperature, so as to obtain correct mixing. Furthermore, mixing the polymer material with the reactive fillers can be achieved in several operations. For example, a master batch is prepared with a high reactive filler concentration. The premix is then diluted in a subsequent operation.

The stage of preparing and implementing the mixture of polymer material and of chemically reactive fillers with the acid compounds H₂S and/or CO₂ is important. Indeed, preferably, the chemically reactive fillers are homogenously distributed in the polymer material. In fact, homogeneous distribution of the reactive fillers allows the acid compounds to be neutralized over the entire surface of the sheath and prevents the formation of preferential acid compound passageways in the sheath, which would lead to a rapid release of the acid compounds through the sheath and thus to low efficiency. Furthermore, an inhomogeneous local concentration of reactive fillers in the sheath could cause weak mechanical resistance of the sheath. It has been discovered that, below a given grain size value, the distribution of the filler in the polymer matrix is no longer sufficiently homogeneous to improve the action of the filler. Fillers in form of granules whose average diameter, in volume, D50 (i.e. 50% of the granulates are in this range) measured by dry laser particle sizing, is above 0.02 μm and below 150 μm, preferably below 30 μm, are therefore preferably used according to the invention.

Pipe According to the Invention

The invention furthermore relates to a pipe for transporting a petroleum effluent comprising at least one acid compound. The pipe comprises at least one sheath made from the composition according to the invention for neutralizing the amount of acid compound that would flow through said sealing sheath by permeability.

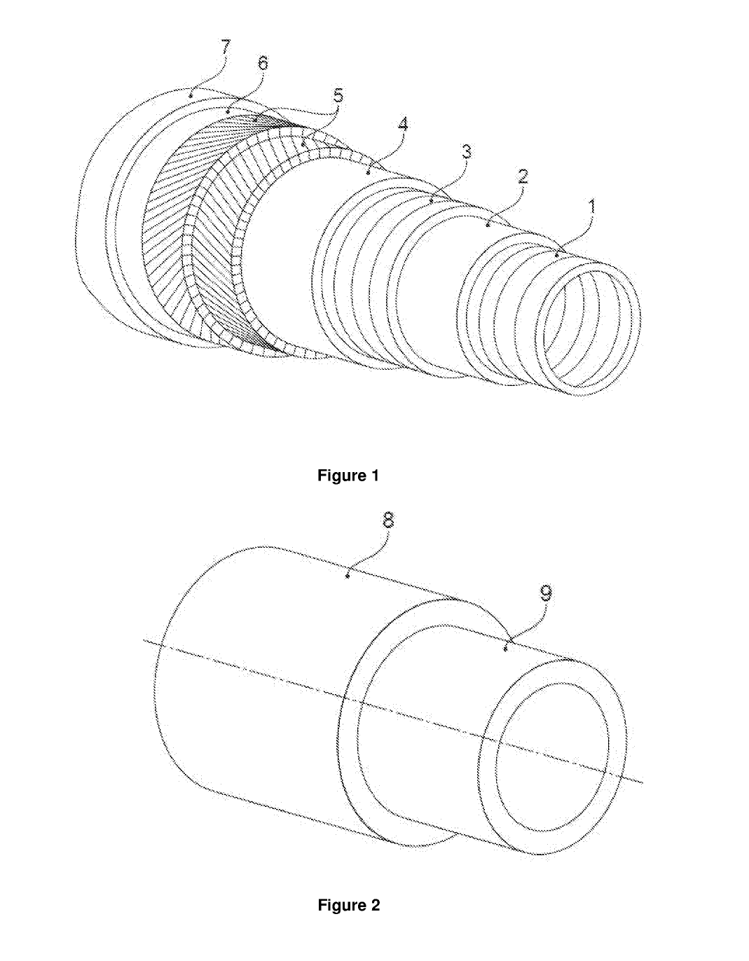

The flexible pipe shown in FIG. 1 is made up of several layers described hereafter from the inside to the outside of the pipe.

Carcass 1 consists of a metal strip helically wound with a short pitch. It is intended to provide resistance to collapse due to the external pressure applied to the pipe. The metal strip can be made from a deformed sheet or a wire, each spire being stapled to adjacent spires.

Sealing sheaths 2 and 4 are formed by extrusion of a polymer material generally selected from among polyolefins, polyamides and fluorinated polymers.

Vault 3 made of stapled or interlocking metal wires provides resistance to the internal pressure in the pipe.

Tensile armour plies 5 consist of metal wires helically wound at angles ranging between 20° and 55°. The plies are maintained by a tape 6.

Polymer sheath 7 provides an external protection for the pipe.

According to the invention, at least one of sealing sheaths 2 or 4 comprises chemically active fillers with H₂S and/or CO₂.

The pipe shown in FIG. 1 is of rough bore type, i.e. the fluid circulating in the pipe is in contact with carcass 1.

Alternatively, the pipe can be of smooth bore type. In this case, the pipe shown in FIG. 1 comprises no carcass 1. Polymer sheath 2 is directly in contact with the fluid circulating in the pipe.

The pipe schematically shown in FIG. 2 consists of a metal tube 8 whose inner surface is lined with a continuous sealing sheath 9 made from a polymer material.

According to the invention, sheath 9 comprises chemically active fillers with H₂S and/or CO₂.

According to the invention, sealing sheaths 2, 4, 9 are made from the composite material composition according to the invention. This composition allows to irreversibly neutralize the corrosive effects of the acid compounds and to limit the corrosive effects on the metallic elements of the pipe. Besides, this mixture exhibits all the characteristics required within the scope of the invention in terms of mechanical properties, barrier properties, and thermal and chemical resistance.

One variant of the invention consists in achieving said sheath by superposing two polymer layers, a first layer, close to the boron, in contact with the production fluid, whose purpose is to limit the acid gas permeation rate, and a second layer thus making up the anti-acid compound barrier.

The polymer type is selected considering the scope of the invention, i.e. rigid or flexible oil pipes.

According to the invention, the mass proportion (also referred to as mass fraction) of acid compound neutralizing agents in the sheath can range between 4 and 40 mass %, preferably between 10 and 30%. Indeed, for mass concentrations below 4%, the thickness of sheath 2, 4, 9 required to obtain an acceptable efficiency could be too great to enable insertion in a flexible pipe. For mass concentrations of acid compound neutralizing agents above 40%, the mechanical strength properties of sheath 2, 4, 9 could be incompatible with the application; in fact, adding a filler to the polymer matrix tends to decrease the mechanical properties, notably the elongation at break.

It is also possible to reduce the rate of diffusion of the acid gases through the sheath using fillers that reversibly trap the acid gases, for example activated carbon particles, zeolites or aluminas. This trapping, or adsorption, temporary or not, allows on the one hand to slow down the flow of acid molecules into the polymer matrix and, on the other hand, to increase the reaction probability between an acid molecule and a reactive filler. All this tends to increase the efficiency of the polymer membrane comprising reactive fillers irreversibly and reactive fillers reversibly.

According to a particular embodiment of the invention, the sealing sheath respectively bearing reference number 2 and/or 4 in FIG. 1 or 9 in FIG. 2 can be made in several layers.

A multilayer polymer sheath allows to dedicate one layer to the function of acid compound barrier, the mechanical or thermal stresses being then taken up by another layer.

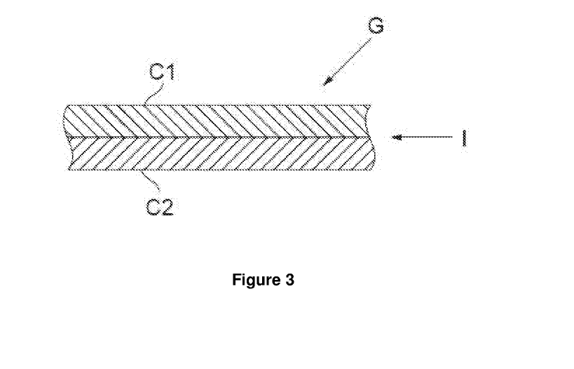

In reference to FIG. 3, sheath G is made in two layers C1 and C2. Layers C1 and C2 are successively extruded. For example, layer C1 is extruded on a core, then layer C2 is extruded on layer C1 to obtain a sheath whose layer C1 is inside and layer C2 is outside. Layer C1 is made with a neutralizing agent-free polymer material thus providing good mechanical and thermal strength of sheath G. Preferably, layer C1 is made from a fluorinated thermoplastic material, for example PVDF or PVDF-HFP. Furthermore, layer C1 allows to limit the flow of acid compounds through sheath G. Layer C2 comprises a mixture of polymer materials selected from the vinylidene fluoride copolymers family, comprising at least one monomer selected from among the following monomers: hexafluoropropylene, perfluoro(methylvinyl)ether, perfluoro(ethylvinyl)ether, perfluoro(propylvinyl)ether, tetrafluoroethylene, perfluorobutylethylene, fluoropropylene, chlorotrifluoroethylene, chlorodifluoroethylene, chlorofluoroethylene, trifluoroethylene, and the monomers with the following formulation: CH₂═CH—CF₂—(CF₂)₄—CF₃, and of neutralizing agent fillers acting as a barrier against acid compounds (anti-H₂S material). This embodiment affords the advantage of selecting a polymer material for layer C₂ that accepts the presence of neutralizing agents and that does not necessarily require the characteristics needed for the function of layer C1, for example low gas permeability, explosive decompression resistance. Layer C1 acts as a sealing sheath, it therefore limits the acid gas flow that might reach layer C2. Furthermore, it can also act as a thermal barrier since it limits the temperature undergone by layer C2.

In order to reduce the permeability of sheath G and thus to allow the acid compound concentrations to be reduced at interface I between layers C1 and C2, according to the invention, lamellar fillers can be fed into layer C1 (lamellar fillers with a shape factor above 20). The lamellar fillers according to the invention can be selected from among exfoliated smectites, talcs, micas, graphites, graphenes for example. Their main purpose is to increase the tortuosity of the acid compound passageways in the sheath.

The composition according to the invention can also be used for acid gas cleaning processes and/or for manufacturing sealing sheaths for any other application requiring acid gas neutralization.

1. A composite material composition for neutralizing at least one acid compound among carbon dioxide CO₂ and hydrogen sulfide H₂S, said composition comprising a mixture of a polymer material with a predetermined amount of chemically active products with said acid compound so as to irreversibly neutralize the corrosive effects of said acid compounds, characterized in that the mass fraction of said chemically active products ranges between 4 and 40% and said polymer material is selected from the vinylidene fluoride copolymers family, comprising at least one monomer selected from among the following monomers: hexafluoropropylene, perfluoro(methylvinyl)ether, perfluoro(ethylvinyl)ether, perfluoro(propylvinyl)ether, tetrafluoroethylene, perfluoro-butylethylene, fluoropropylene, chlorotrifluoroethylene, chlorodifluoroethylene, chloro-fluoroethylene, trifluoroethylene, and the monomer with the following formulation: CH₂═CH—CF₂—(CF₂)₄—CF₃.

2. A composition as claimed in claim 1, wherein the polymer material is a copolymer of poly-(tetrafluoroethylene-co-hexafluoropropylene-co-vinylidene fluoride) THV type.

3. A composition as claimed in claim 1, wherein the polymer material is a copolymer of poly(vinylidene fluoride-co-hexafluoropropylene) PVDF-HFP type.

4. A composition as claimed in claim 1, wherein the polymer material is a mixture of several polymers.

5. A composition as claimed in claim 1, wherein the fluorinated vinylidene copolymer has a tensile modulus measured at 20° C. ranging between 300 MPa and 850 MPa, preferably between 400 MPa and 600 MPa, with either a tensile elongation at yield at ambient temperature above 12%, preferably above 15% and more preferably above 20%, or a behaviour similar to that of an elastomer.

6. A composition as claimed in claim 1, wherein the polymer material has a melting temperature ranging between 140° C. and 250° C., preferably between 160° C. and 230° C.

7. A composition as claimed in claim 1, wherein said chemically active products are selected from among the metal oxides selected from the group consisting of Fe₂O₃, MnO₂O₃, Mn₃O₄, MnO₂, PbO, ZnO, NiO, CoO, CdO, CuO, SnO₂, MoO₃, Fe₃O₄, Ag₂O, CrO₂, CrO₃, Cr₂O₃, the alkaline and alkaline-earth oxides selected from among CaO, Ca(OH)₂ and MgO.

8. A composition as claimed in claim 1, wherein said chemically active products are selected from among metal carbonates, metal chlorides, hydrated forms of metal carbonates and metal chlorides, hydroxylated forms of metal carbonates and metal chlorides, alkaline carbonates, alkaline-earth carbonates, alkaline chlorides, alkaline-earth chlorides, hydrated forms of alkaline carbonates, of alkaline-earth carbonates, of alkaline chlorides, of alkaline-earth chlorides and hydroxylated forms of alkaline carbonates, of alkaline-earth carbonates, of alkaline chlorides and of alkaline-earth chlorides.

9. A composition as claimed in claim 1, wherein the mass fraction of said chemically active products ranges between 10% and 30%.

10. A composition as claimed in claim 1, wherein said chemically active products are introduced into said mixture in form of particles with a specific surface area above 5 m²/g, preferably above 50 m²/g and more preferably above 80 m²/g.

11. A composition as claimed in claim 1, wherein said chemically active products are subjected to a chemical surface treatment with silanes.

12. A composition as claimed in claim 1, wherein said polymer material comprises a processing aid.

13. A composition as claimed in claim 3, wherein the PVDF-HFP used comprises plasticizers with a concentration below 10% and preferably below 5%.

14. A composition as claimed in claim 3, wherein the PVDF-HFP material comprises a compatibilizing additive.

15. A pipe for transportation of a petroleum effluent comprising at least one acid compound among carbon dioxide CO₂ and hydrogen sulfide H₂S, said pipe comprising at least one metallic element (3; 8) and a tubular sheath (2; 4; 9), said metallic element (3; 8) being arranged outside of said sheath (2; 4; 9), characterized in that said sheath is made from the composition as claimed in claim 1.

16. A pipe as claimed in claim 15, wherein said sheath (2; 4; 9) comprises at least two layers (C1, C2), a first layer (C1) comprising a second polymer material, and a second layer (C2) comprising said composition as claimed in claim 1.

17. A pipe as claimed in claim 16, wherein said second layer (C2) is arranged within said first layer (C1).

18. A pipe as claimed in claim 16, wherein said second polymer material is selected from among polyvinylidene fluoride PVDF, poly(vinylidene fluoride-co-hexafluoropropylene) PVDF-HFP, polyamides 11 and 12.

19. A pipe as claimed in claim 16, wherein said first layer (C1) also comprises lamellar fillers with a shape factor above 20, selected from among exfoliated talcs, micas, graphites.

20. A pipe as claimed in claim 15, wherein said sheath (2; 4; 9) also comprises adsorbent fillers that trap the acid compounds, the adsorbent fillers being selected from among activated carbon, zeolites and aluminas.

21. A composition as claimed in claim 15, wherein said metallic element (3; 8) is a metal reinforcement of a flexible pipe.

22. A pipe as claimed in claim 15, wherein said metallic element (3; 8) is a metal tube of a rigid pipe.
